(19) United States
(12) Patent Application Publication
(10) Pub. No.: US 2008/0077624 A1
(43) Pub. Date: Mar. 27, 2008

(54) METHOD FOR HIGH PERFORMANCE OPTIMISTIC ITEM LEVEL REPLICATION

(75) Inventors: Russell L. Holden, Boxborough, MA (US); William A. Spencer, Westford, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,815

(22) Filed: Sep. 21, 2006

(51) Int. Cl. G06F 17/30

(52) U.S. Cl. 707/200

(57) ABSTRACT

A method, article, and system for rapidly replicating a data record change in a database while minimizing the need for the database servers to negotiate what data will be replicated, by allowing the source server to independently decide what changes the destination server requires. The minimization of the required negotiations between servers results in a reduction in Central Processor Unit (CPU) utilization and provides improved CPU availability, improved network bandwidth, and a lower end-to-end replication delay. For replication to detect what items have changed, each data record must be associated with a sequence number to identify the number of changes that have occurred to the data record since it was created.

### BACKGROUND OF THE INVENTION

1. Field of the Invention

This invention relates generally to electronic software that manages database servers, and more particularly to providing a method, article, and system for rapidly replicating a data record change in a database while minimizing the need for the database servers to negotiate what data will be replicated, by allowing the source server to independently decide what changes the destination server requires.

2. Description of the Related Art

Data replication refers to the generation and maintenance of multiple copies of data called replicas, on separate computers or servers in a distributed system. The replication process improves data availability by allowing access to the data even when not all of the replicas are available. Replication improves system performance by reducing latency, allowing system users access to nearby replicas and avoiding remote network access, and increased system throughput by allowing multiple computers or servers to act on the data simultaneously. The need for improved management of replicated data in distributed databases has increased tremendously with the growth of telecommunications and the Internet. Telecommunication and Internet applications require rapid distribution of updates to all replicas with a high degree of consistency and availability

The traditional approach to data replication has been to maintain single-copy consistency, and providing the user with the illusion of having a single, highly available copy of the required data. The traditional approach relies on blocking access to a replica unless its contents are up to date. This traditional approach for data replication is called a pessimistic one. In a pessimistic system, a primary replica is responsible for handling all accesses to a particular data object. Following an update, the primary replica synchronously writes the change to the secondary replicas distributed throughout the system. If the computer or server with the primary replica crashes, the remaining replicas confer to elect a new primary. The pessimistic data replication method is well suited for local-area networks that have small latencies and where failures are uncommon. However, for wide-area networks, the Internet, and telecommunication applications the pessimistic data replication approach is suboptimal, and requires new methods such as optimistic replication.

Optimistic replication provides for sharing data in a manner that is well suited for wide-area networks and telecommunication applications. The main difference in the approaches taken by the optimistic and pessimistic replication methods is their approach to concurrency control. The pessimistic method synchronously coordinates replicas during accesses and blocks other users during the updating process. Whereas the optimistic method allows data to be accessed without a priori synchronization based on the “optimistic” assumption that problems will occur only in rare instances. Data updating is carried out in the background, and occasional conflicts are addressed after they occur. However, current methods require negotiation between the primary (source) and destination servers during replication to determine what data is required to be replicated. The present invention provides further improvements to the optimistic method by minimizing and/or eliminating the need for the database servers to negotiate what data will be replicated, by allowing the source server to independently decide what changes the destination server requires. The source server makes an “optimistic” decision regarding what data should be replicated to the destination servers.

The present invention is directed to addressing, or at least reducing, the effects of, one or more of the problems set forth above, by rapidly replicating a data record change in a database while minimizing the need for the database servers (computer servers, main frame computers, desktop computers; and mobile computers) to negotiate what data will be replicated, by allowing the source server to independently decide what changes the destination server requires. The minimization of the required negotiations between servers results in a reduction in Central Processor Unit (CPU) utilization and provides improved CPU availability, improved network bandwidth, and a lower end-to-end replication delay. For replication to detect what items have changed, each data record is associated with a sequence number to identify the number of changes that have occurred to the data record since it was created.

### SUMMARY OF THE INVENTION

Embodiments of the present invention include a method for rapidly replicating a change in a distributed database while minimizing the need for a database to negotiate what content will be replicated, by allowing a source database to independently decide what changes a destination database requires. The minimization of negotiation between the databases during content replication results in a reduction in Central Processor Unit (CPU) utilization, and provides improved CPU availability, improved network bandwidth, and a lower end-to-end replication delay. The method comprises a source database undergoing a change in its content, and the source database assigning sequence identification tags to the content. The source database identifies the most recent content changes, and sends the changed content to a destination database. The destination database analyzes the changed content from the source database by comparing it to its own content. The destination database updates its content if it determines that the changed content differs from it own. The source database sends the most recent changes to the destination database, without knowledge of whether the destination database already had the change, or if it was up to date with the source database contents. The sequence identification tags, of the present invention, track the number of changes the content has undergone since its creation. When a change occurs the sequence identification tag number is incremented. The sequence identification tags may further comprise timing information. Only the highest sequenced identified changes are sent by the source database to the destination database. The timing information is used to avoid conflicts caused by a destination database being simultaneously and independently changed by more then one source database. The destination database employs the use of the sequence identification tags in its analysis to determine whether its contents are up to date. The databases of the method of the present invention comprise: computer servers; mainframe computers; desktop computers; and mobile computing devices. In an instance where a database sends a change message to a destination database, and the destination database has already been updated in accordance with the change message, the change message is disregarded by the destination database. Additionally, when a destination database is in the process of receiving a change from the source database, and the destination database determines it is missing content, the destination database requests the missing content from the source database.

A system for implementing the method of the present invention, as well as, an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C illustrate the replication process according to an embodiment of the present invention.

FIG. 2 depicts what occurs when a server receives replicated data that it already has according to an embodiment of the present invention.

FIG. 3 illustrates a scenario of why a server may receive replicated data that it already has according to an embodiment of the present invention.

FIG. 4 depicts what occurs when a server realizes that it is missing information during a replication update according to an embodiment of the present invention.

FIG. 5 illustrates a computing/server system to implement the optimistic item level replication according to an embodiment of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method and system for rapidly replicating a data record change in a database while minimizing the need for the database servers to negotiate what data will be replicated, by allowing the source server to independently decide what changes the destination server requires. The minimization of the required negotiations between servers results in a reduction in Central Processor Unit (CPU) utilization and provides improved CPU availability, improved network bandwidth, and a lower end-to-end replication delay. For replication to detect what items have changed, each data record is associated with a sequence number to identify the number of changes that have occurred to the data record since it was created.

When a data record in the database is changed, the information needs to be replicated to all other replicas of the database. Each data record in a database may contain multiple “Items”. An item is a unit (or part) of the data record that has a name (or label), and contains data. The exact format of an item is implementation dependant, but the basic idea is that a data record can be broken down into several distinct items. An example might be a data record in a discussion database. The data record in the database might contain multiple meta-data items such as “Author”, “Subject”, “Body”, and “Time”. Each of these items might be changeable by the user or the application. As the items change, the changes must replicate to other servers containing replicas of this database. The other servers will apply the changes to the other replicas of the databases, keeping all the replicas in sync.

One method of replication involves negotiation between servers. This might involve the source server (the server where the data record change occurred) contacting the destination server (another server containing a replica of the database) to determine which data records have changed, and what the changes are. Negotiation of what changes to replicate will cause only the necessary changes to replicate, but involves a higher overhead since a number of network operations would be involved in negotiating replication. To minimize the overhead associated with replication, a new method of replication involves an “optimistic” approach to replicating data. This method of replication eliminates the negotiation between servers, by allowing the source server to independently decide what changes it thinks the destination server requires. The source server identifies the most recent item changes for the changed data record, and immediately sends these to the destination server, without knowledge of whether the destination server already had the change, or if it was up to date with the source server.

In order for optimistic replication to detect what items have changed, each data record is associated with a sequence number to identify how many changes have been made to the data record since creation. For example, when a new data record is created, it will be associated with a sequence number of 1. As changes are made to the data record, the sequence number is incremented. A sequence number is associated with each item corresponding to the sequence number of the data record when the item was changed. If a given item sequence number is the same as the data record sequence number, then the change in the item corresponded to the most recent change to the data record. In addition, multiple items can be changed during one change to the data record. For example, a user or application may change multiple items during a single change. These items that are changed will have the same sequence number, which will also correspond to the data record sequence number. Please see Table 1 example for an illustration.

TABLE 1

| | |
|---|---|
| Item | Sequence Number |

User creates a new data record with 3 items (Item 1, Item 2, and Item 3)
Record A Sequence number = 1

| | |
|---|---|
| Item 1 | 1 |
| Item 2 | 1 |
| Item 3 | 1 |

A user or application changes item 2
Record A Sequence number = 2

| | |
|---|---|
| Item 1 | 1 |
| Item 2 | 2 |
| Item 3 | 1 |

A user or application changes items 2 and 3
Record A Sequence number = 3

| | |
|---|---|
| Item 1 | 1 |
| Item 2 | 3 |
| Item 3 | 3 |

When the source server detects that a data record has changed, it collects the items that have the same sequence number as the data record itself (in other words, the items that were most recently changed) and sends these to the next replication server in the replication topology for this replica of the database. Only the highest sequenced items are delivered to the adjacent servers. The destination server, upon receiving the updated items will apply the items to its replica of the database. The destination server may then relay the information to other adjacent servers (if any) with replicas of the database.

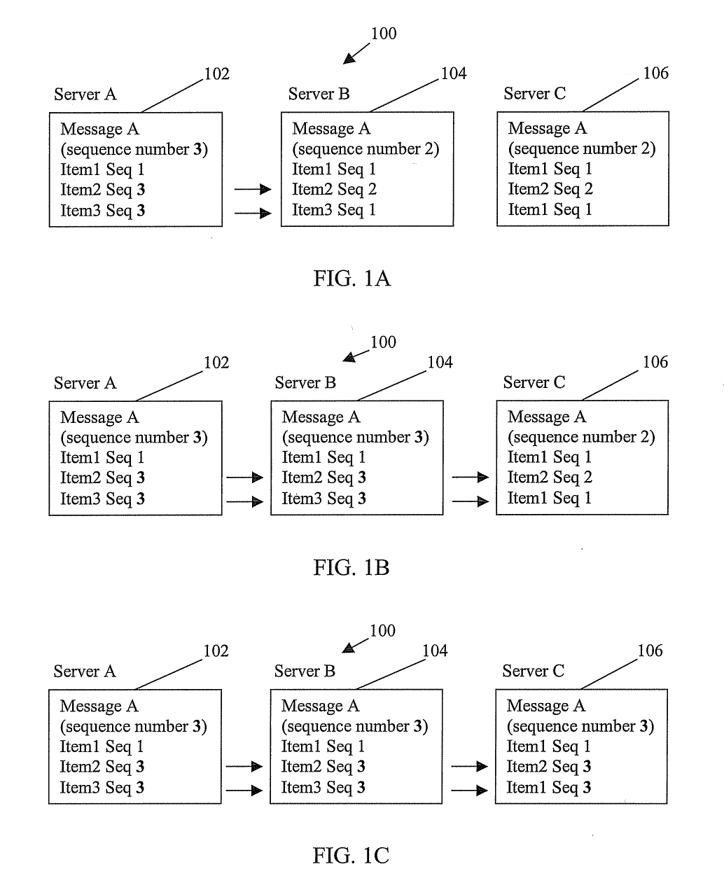

FIGS. 1A-1C illustrate the replication process of a preferred embodiment of the present invention. A system 100, which for the purpose of this example only is made up of three servers (Server A 102, Server B 104, Server C 106). In FIG. 1A the source server is Server A 102 that detects a change and the highest sequenced items (Item2 and Item3) are sent to Server B 104. In FIG. 1B Server B 104 applies the received information to its database, and subsequently replicates the changes to Server C 106. In FIG. 1C the Server C updates its database with the changes received from Server B 104.

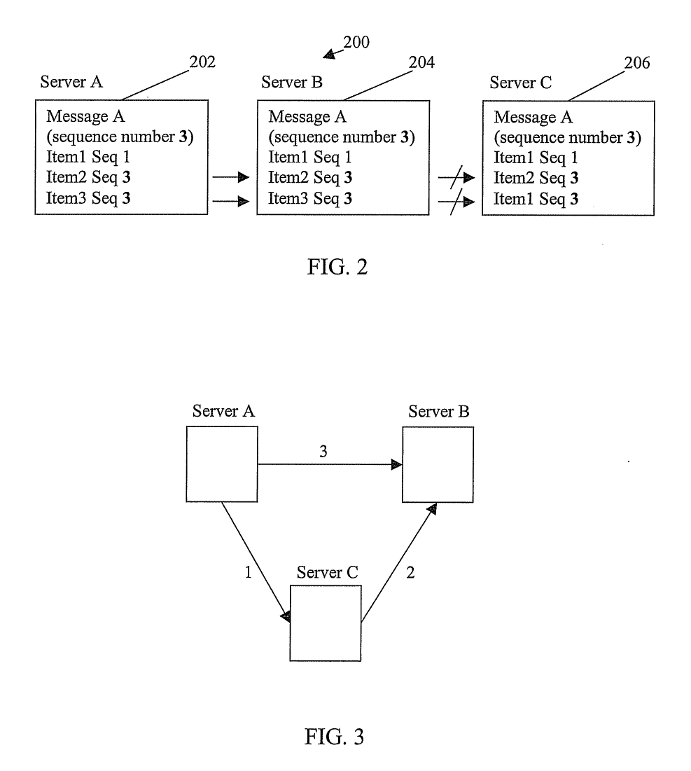

FIG. 2 illustrates what occurs in a system 200 when Server B 204 receives information that is not new from Server A 202. In this case Server B 204 already has the information that it received from Server A 202, and it will discard (ignore) the incoming replicated data and not relay it to Server C 206.

The situation that is illustrated in FIG. 2 might happen if Server B received the information from another server before receiving the information from Server A. For example, in the system 300 of FIG. 3, if the information replicated from Server A 302 to Server C 306 and from Server C 306 to Server B 304 before the information replicated from Server A 302 to Server B 304.

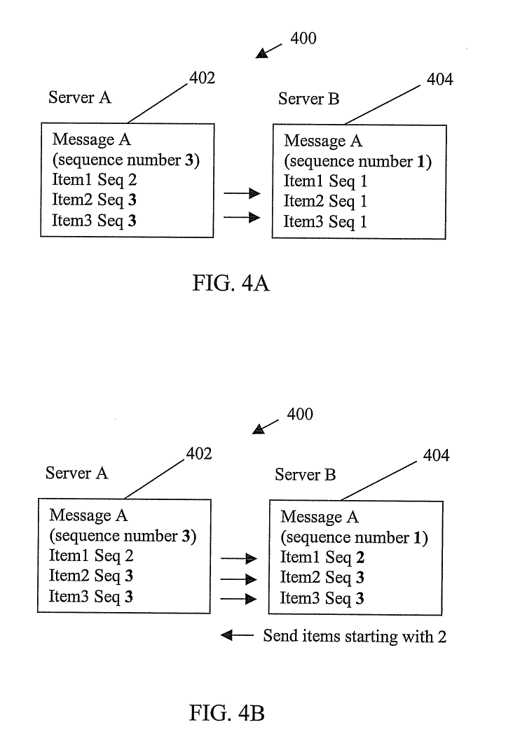

FIGS. 4A and 4B illustrate what occurs in a system 400 when a destination server (Server B 404) receives information from a source server (Server A 402), but realizes that it is missing information (FIG. 4A). In this instance the destination server (Server B 404) will need to request more data from the source server (Server A 402). The destination server can request more information from the source server by a reply message that indicates that the Destination server needs more data, and the destination server can give the source server a sequence number above which it needs item changes. In the example of FIGS. 4A and 4B, the Server B 404 requests items starting with 2. This form of negotiation between the source and destination servers should only occur in rare instances, possibly due to the destination server being off the network for a period of time.

Embodiments of the present invention may also need to handle conflicts that would be caused by an item being simultaneously and independently changed on more than one server. In order to detect conflicts, there would need to be a record of time stamps for each of the data record changes done on a source server. This record of time stamps might be kept in an item of the data record. The implementation would use this record of changes to detect that a conflict has occurred, and will need to deal with the conflict in an implementation specific manner.

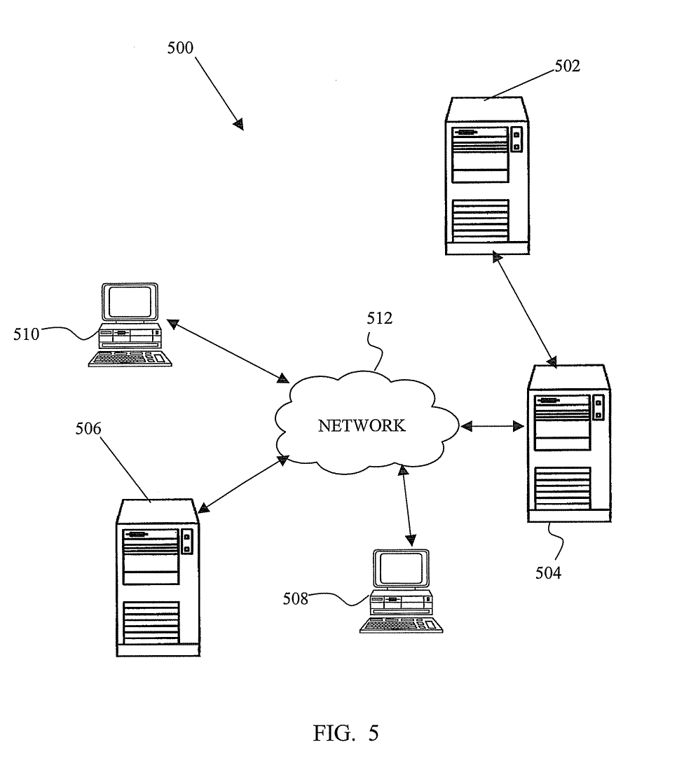

FIG. 5 is a block diagram of an exemplary system 500 for implementing the high performance optimistic item level replication of the present invention and graphically illustrates how those blocks interact in operation. The system includes one or more computing/communication devices (508, 510) coupled to a system of servers 502, 504, 506) to each other or via a network 512. Each computing/communication device (508, 510) may be implemented using a general-purpose computer executing a computer program for carrying out the processes described herein. The computing/communication devices (508, 510) may also be, but are not limited to, portable computing devices, wireless devices, personal digital assistants (PDA), cellular devices, etc. The computer program that implements the present invention may be resident on a storage medium local to the computing/communication devices (508, 510), or maybe stored on the server system (502, 504, 506). The server system represented by servers 502, 504, and 506 may belong to a public service provider, or to an individual business entity or private party. The network 512 may be any type of known network including a local area network (LAN), wide area network (WAN), global network (e.g., Internet), intranet, wireless or cellular network, etc. The computing/communication devices (508, 510) may be coupled to the server system (502, 504, 506) through multiple networks (e.g., intranet and Internet) so that not all computing/communication devices (508, 510) are coupled to the server system (502, 504, 506) via the same network. In a preferred embodiment, the network 512 is a LAN over which the replication process of the present invention is carried out between all the devices within the system (502, 504, 506, 508, 510) that have access to and require updated database information.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for rapidly replicating a change in a distributed database while minimizing the need for a database to negotiate what content will be replicated, by allowing a source database to independently decide what changes a destination database requires said method comprising:
said source database undergoing a change in its content; and
said source database assigning sequence identification tags to said content; and
said source database identifying the most recent changes, and sending said changed content to said destination database; and
wherein said destination database analyzes said changed content from said source database by comparing it to its own content; and
wherein said destination database updates its content if it determines that said changed content differs from it own.

2. The method of claim 1 wherein said source database identifies the most recent content changes, and sends said most recent changes to said destination database, without knowledge of whether the destination database already had the change, or if it was up to date with the source database contents.

3. The method of claim 1 wherein said sequence identification tags track the number of changes said content has undergone since its creation; and
wherein when a change occurs said sequence identification tag number is incremented.

4. The method of claim 3 wherein only the highest sequenced identified changes are sent by said source database to said destination database.

5. The method of claim 3 wherein said sequence identification tags further comprise timing information.

6. The method of claim 5 wherein said timing information is used to avoid conflicts caused by a destination database being simultaneously and independently changed by more then one source database.

7. The method of claim 1 wherein said destination database employs the use of said sequence identification tags in its analysis to determine whether its contents are up to date.

8. The method of claim 1 wherein said database comprises: computer servers; mainframe computers; desktop computers; and mobile computing devices.

9. The method of claim 1 wherein when said source database sends a change message to said destination database; and
wherein said destination database has already been updated in accordance with said change message, said change message is disregarded by said destination database.

10. The method of claim 1 wherein when said destination database is in the process of receiving a change from said source database, and said destination database determines it is missing content, said destination database requests said missing content from said source database.

11. The method of claim 1 wherein the minimization of negotiation between said database during content replication results in a reduction in Central Processor Unit (CPU) utilization, and provides improved CPU availability, improved network bandwidth, and a lower end-to-end replication delay.

12. An article comprising one or more machine-readable storage media containing instructions that when executed enable a processor to access an optimistic replication program; and
wherein said optimistic replication program facilitates groups of database to share replicated data; and
wherein said optimistic replication program provides for rapidly replicating a change in a distributed database while minimizing the need for said database to negotiate what content will be replicated, by allowing a source database to independently decide what changes a destination database requires.

13. The article of claim 12 wherein said database comprises: computer servers; mainframe computers; desktop computers; and mobile computing devices.

14. The article of claim 12 wherein the minimization of negotiation between said database during content replication results in a reduction in Central Processor Unit (CPU) utilization, and provides improved CPU availability, improved network bandwidth, and a lower end-to-end replication delay.

15. The article of claim 12 wherein said source database identifies the most recent content changes, and sends said most recent changes to said destination database, without knowledge of whether the destination database already had the change, or if it was up to date with the source database contents.

16. The article of claim 12 wherein said database assigns sequence identification tags to said content; and
wherein said sequence identification tags track the number of changes said content has undergone since its creation; and
wherein when a change occurs said sequence identification tag number is incremented.

17. The article of claim 16 wherein said sequence identification tags further comprise timing information.

18. The article of claim 16 wherein only the highest sequenced identified changes are sent by said source database to said destination database.

19. The article of claim 16 wherein said destination database employs the use of said sequence identification tags in its analysis to determine whether its contents are up to date.

20. A system for rapidly replicating a change in a distributed database while minimizing the need for a database to negotiate what content will be replicated, by allowing a source database to independently decide what changes a destination database requires, said system comprising computing devices and at least one network; and
wherein said computing devices implement said database; and
wherein said computing devices further comprise:
computer servers;
mainframe computers;
desktop computers; and
mobile computing devices; and
wherein said computing devices execute electronic software that manages said data replication; and
wherein said electronic software is resident on a storage medium; and
wherein said computing devices have the ability to be coupled to said network; and
wherein said network further comprises:
local area network (LAN);
wide area network (WAN);
a global network;
the Internet;
a intranet;
wireless networks; and
cellular networks.
